(19) United States
(12) Patent Application Publication
(10) Pub. No.: US 2003/0026905 A1
(43) Pub. Date: Feb. 6, 2003

(54) Process for the microbicidal impregnation of porous materials

(75) Inventors: Peter Ottersbach, Windeck (DE); Friedrich Sosna, Dorsten (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CREAVIS GESELLSCHAFT F. TECHN. U. INNOVATION MBH, Marl (DE)

(21) Appl. No.: 10/211,373

(22) Filed: Aug. 5, 2002

(30) Foreign Application Priority Data
Aug. 4, 2001 (DE) 101 38 407.6

(51) Int. Cl. B05D 3/00

(52) U.S. Cl. 427/331

(57) ABSTRACT

The present invention relates to a process for preparing porous materials having antimicrobial properties by impregnating them with antimicrobial polymers.

### BACKGROUND OF INVENTION

1. Field of the Invention

The present invention relates to a process for preparing porous materials having antimicrobial properties by impregnating them with antimicrobial polymers.

2. Discussion of the Background

Porous materials having large surface area are very susceptible to microbial infestation. Microbial infestation of porous materials ruins the appearances of the materials and eventually leads directly to mechanical defects and breakdown of the materials. In extreme cases where the microbial infestation spreads throughout the materials, complete destruction of the porous materials may result. Such processes of microbial breakdown of porous materials are known as biocorrosion.

Molds, such as Aspergillus niger, are known to cause biocorrosion. Molds penetrate the pores of porous materials such as concrete, sandstone, wood, or glass. The metabolism of molds occupying pores of porous materials causes the gradual destruction of the surfaces of porous materials.

The metabolic products released by molds occupying the pores of porous materials may lead to impaired health in humans. For example, humans may be susceptible to allergies when in contact with such metabolic products, which may cause acute shock or chronic sensitizations. Porous materials that are regularly used outdoors are subject to stress. These materials include wooden constructions, such as wooden houses, garden sheds, tool sheds, railroad ties, wooden swings, park benches, and wooden bridges. Outdoor materials are susceptible to stress caused by various temperature and moisture conditions. Furthermore, these porous materials for outdoor use are very sensitive to stress associated with microbial infestations.

At a time prior to the present invention, biocorrosion has been combated with two methods. First, a protective layer of hydrophobic coating is applied to the surface of porous materials to prevent water and microbes from contacting the surface. However, this method is only effective for short periods of time because microbes find ways to attach themselves to hydrophobic the surfaces. Second, low molecular mass biocides are added to coating materials and then applied to the surfaces of the porous materials. However, this method does not endure long exposures to moisture because such coatings have been shown to wash away from the surface of the porous material after just one downpour of rain. Therefore, this method is generally reserved for interior use, such as for coating frescoes, sculptures, and paintings.

In order to increase the longevity of protection to porous materials used outdoors, coatings containing biocides have been impregnated by vacuum pressure. However, such biocides are toxic to humans as they eventually leech out of the treated porous material.

U.S. Pat. No. 5,094,892 describes a process in which a wood preservative can be introduced into wood materials by means of a supercritical solvent, such as carbon dioxide, and a cosolvent. The supercritical solvent and the cosolvent are first mixed. Then, the mixture takes up the wood preservative. Finally, this mixture is used to impregnate the wood under supercritical conditions. Unfortunately, wood preservatives are not very soluble in the supercritical solvent. In fact, only wood preservatives containing copper compounds have been found to be soluble in the supercritical solvent. Copper compounds are hazardous to the environment; and therefore, are preferred for use.

European patent application 0 862 858 describes that copolymers of tert-butlyaminoethyl methacrylate, a methacrylate ester with a secondary amino function, is antimicrobial. Furthermore, the three-dimensional structure, conformation, and available surface area of these polymer systems are attributed to their antimicrobial activity. They are well suited for applications where the sustainable long-lasting protection of a surface from microbial infestation is desired.

The German patent application 10 062 201.1 describes using antimicrobial polymers in the preservation of buildings and monuments. However, this process does not permit adequate penetration of antimicrobial polymers into the treated materials. As a result, the surface suffers mechanical damage that may result in the destruction of the material's protection.

German Patent Application 101 22 149.5 describes using supercritical media to impregnate materials. However, the high pressures and specific equipment needed are very complicated.

Prior to the present invention, to provide ways of adequately impregnating porous materials with antimicrobial polymers without the use of supercritical media.

### SUMMARY OF THE INVENTION

It is an object of the present invention is to protect porous materials from microbial infestation and subsequent deterioration for extended periods of time.

It is another object of the present invention to provide methods of impregnating porous materials with antimicrobial polymers at adequate depth penetration into the surface of such porous materials.

It is another object of the present invention is to provide methods of impregnating porous materials with antimicrobial polymers by introducing the antimicrobial polymers into the matrix of porous materials with pressure.

It is another object of the present invention is to provide methods of impregnating porous materials with antimicrobial polymers by applying a solution or dispersion of an antimicrobial polymer to the porous material and then exposing a porous material to which an antimicrobial polymer has been applied to a pressure of from 2 to 100 bar.

It is another object of the present invention is to provide a porous material impregnated with antimicrobial polymers by applying a solution or dispersion of the antimicrobial polymer to the porous material and then exposing a porous material to which an antimicrobial polymer has been applied to a pressure of from 2 to 100 bar.

The present invention is based, in particular, on the discovery that a porous material can be impregnated with an antimicrobial polymer exposing the porous material to which an antimicrobial polymer has been applied to a pressure of from 2 to 100 bar.

The objects of the present invention may be accomplished by a process comprising contacting a solution or a dispersion of an antimicrobial polymer to a porous material and then exposing a porous material to which an antimicrobial polymer has been applied to a pressure of from 2 to 100 bar.

The above descriptions highlight certain aspects and embodiments of the present invention. The objects of the present invention may be also accomplished by the additional objects, aspects, and embodiments of the present invention that follow in the detailed description of the present invention considered together with the Examples.

### DETAILED DESCRIPTION OF THE INVENTION

Unless specifically defined, all technical and scientific terms used herein have the same meaning as commonly understood by a skilled artisan in biochemistry, chemistry, and materials science.

Although methods and materials similar or equivalent to those described herein can be used in the practice or testing of the present invention, suitable methods and materials are described herein. All publications, patent applications, patents, and other references mentioned herein are incorporated by reference in their entirety. In case of conflict, the present specification, including definitions, will control. Further, the materials, methods, and examples are illustrative only and are not intended to be limiting.

The inventors have found that it is possible to impregnate porous materials with antimicrobial polymers by a process which is based on vacuum pressure impregnation. The process uses an elevated pressure for efficient introduction of the antimicrobial polymers, and optionally, other auxiliaries into the matrix of the porous materials to be impregnated.

The efficiency of the process may be increased further by removing air from the pores of the porous material by applying subatmospheric pressure prior to application of the antimicrobial polymer.

The present invention provides a process for the antimicrobial impregnation of porous materials with antimicrobial polymers by applying a solution or dispersion of at least one antimicrobial polymer to the porous material.

In the process of the present invention, an antimicrobial polymer may be dissolved in a solvent such as an organic solvent. Suitable solvents include but are not limited to alcohols such as ethanol, methanol, propanol, and isopropanol, acetates such as ethyl acetate, and butyl acetate, ketones such as acetone and methyl ethyl ketone, and aromatics such as toluene and xylene. Further, ethers such as THF, diethyl ether, dioxane, or DMF may be used. Still further, hydrocarbons such as n-hexane and cyclohexane may be used.

Alternatively, the antimicrobial polymer may be dispersed in an aqueous solvent. Suitable dispersion media include but are not limited to emulsifiers such as polyethylene glycol derivatives. Further, the dispersion may include where appropriate, surfactants and/or the abovementioned alcohols.

The concentration of the antimicrobial polymer in the solvent is generally from 1 to 20% by weight. The ranges for the concentration of the antimicrobial polymer in the solvent include all specific values and subranges therebetween, such as 2, 4, 6, 8, 10, 12, 14, 16, and 18% by weight.

Dispersions are prepared in the range of from 0.1 to 20% by weight where appropriate, surfactants, emulsifiers, or the abovementioned alcohols. The ranges for the concentration of the antimicrobial polymer in the dispersion include all specific values and subranges therebetween, such as 0.5, 1, 2, 4, 6, 8, 10, 12, 14, 16, and 18% by weight.

The solution or dispersion may then be applied to the surface of a porous material. Application of the solution or dispersion to the surface of a porous material may occur by brushing, spraying, or immersing the porous material into the solution or dispersion. The solution or dispersion of the antimicrobial polymer may dry on the porous material. Alternatively, the solvent or dispersion material may be removed by distillation for example. This application is considered a pretreatment of the porous material whether or not the solvent or dispersion is dried or removed. The solvent or dispersing agent may be further removed prior to application of the subatmospheric pressure, e.g. by the abovementioned vacuum treatment, by drying, heating, or distilling.

The material thus prepared may be exposed to a pressure of from 2 to 100 bar, preferably from to 2 to 50 bar, and particularly preferably from 5 to 25 bar, in order to press the antimicrobial polymer into the material. The ranges for the pressure include all specific values and subranges therebetween, such as 5, 10, 15, 20, 25, 30, 35, 40, 45, 50, 55, 60, 65, 70, 75, 80, 85, 90, and 95 bar.

After the pressure treatment, air may then be removed again. Further, any excess solvent and processing aids may be removed from the material by applying subatmospheric pressure after the pressure treatment. The treatment at subatmospheric pressure may be carried out prior to and/or after the pressure treatment.

The pretreatment at subatmospheric pressure may be carried out at from 0.01 to 100 mbar, preferably from 1 to 10 mbar. The ranges for the pressure include all specific values and subranges therebetween, such as 0.02, 0.05, 0.1, 0.2, 0.5, 1, 2, 3, 4, 5, 6, 7, 8, and 9 mbar.

Inert gases, such as nitrogen, CO₂, or air are preferably used to generate the pressure of the post-treatment, treatment, and post-treatment.

The antimicrobial property is inherently in the polymer itself. Therefore, leeching of the active antimicrobial species is fundamentally impossible. Furthermore, the antimicrobial polymers possess hydrophilic groups. Such hydrophilic groups swell when in contact with water or moisture, completely filling the pores in which the antimicrobial polymers reside. Water or moisture is required for microbial attack of porous materials. Therefore, the presence of water or moisture leads the polymer to swell and seal off the polymer from microbial infestation. Furthermore, the antimicrobial polymer is much less toxic than low molecular mass biocides, leading to less potential toxicity to humans when the antimicrobial polymer is impregnated into the porous material.

As a result of treating porous materials according to the above, the present invention provides a method of providing porous materials that are durable and resistant to environmental influences and physical stresses. Further, the treated porous materials possess no low molecular mass biocides that can leech from their pores, reducing the odds that environmentally toxic substances will migrate from the porous material throughout use of the porous material.

The antimicrobial polymers are preferably prepared from at least one nitrogen- or phosphorus-functionalized monomer, very particularly preferably from at least one of the monomers selected from the group consisting of 2-tert-butylaminoethyl methacrylate, 2-diethylamino-ethyl methacrylate, 2-diethylaminomethyl methacrylate, 2-tert-butylaminoethyl acrylate, 3-dimethylaminopropyl acrylate, 2-diethyl-aminoethyl acrylate, 2-dimethylaminoethyl acrylate, dimethylaminopropylmethacrylamide, diethylamino-propylmethacrylamide, N-3-dimethylaminopropyl-acrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, allyltriphenylphosphonium bromide, allyltriphenyl-phosphonium chloride, 2-acrylamido-2-methyl-1-propanesulfonic acid, 2-diethylaminoethyl vinyl ether and 3-aminopropyl vinyl ether.

Besides the abovementioned monomers, it is possible to use other monomers, e.g. acrylates or methacrylates, acrylic acid, tert-butyl methacrylate, methyl methacrylate, styrene or its derivatives, vinyl chloride, vinyl ethers, acrylamides, acrylonitriles, olefins (ethylene, propylene, butylene, isobutylene), allyl compounds, vinyl ketones, vinyl acetic acid, vinyl acetate, vinyl esters, ethyl methacrylate, butyl methacrylate, methyl acrylate, ethyl acrylate, butyl acrylate or tert-butyl acrylate, i.e. use is made of an antimicrobial copolymer.

The antimicrobial polymers of the present invention may have a wide range of molecular weight. For example, the antimicrobial polymers may have a weight average molecular weight of from 20,000 to 5,000,000, more preferably from 50,000 to 1,000,000, most preferably from 100,000 to 500,000. The ranges for the weight average molecular weight of the antimicrobial polymers include all specific values and subranges therebetween, such as 20,000, 50,000, 75,000, 100,000, 150,000, 200,000, 250,000, 300,000, 350,000, 400,000, 450,000, 500,000, 750,000, 1,000,000, 1,250,000, 1,500,000, 1,750,000, 2,000,000, 2,500,000, 3,000,000, 3,500,000, 4,000,000, and 4,500,000.

The process of the present invention may be performed at various temperatures. For example, the process may by performed from 10 to 200° C., preferably from 20 to 80° C. The ranges for the temperature include all specific values and subranges therebetween, such as 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170 ,175, 180, 185, 190, and 195° C.

The application of the antimicrobial polymer may or may not be performed alone. In addition, a further steam treatment may be used prior to the application of antimicrobial polymers to the material. The steam treatment may be carried out after an optional vacuum treatment. The steam treatment may be performed prior to the vacuum treatment to clean the material.

It is also possible for the steam treatment to be carried out after application of the antimicrobial polymer but prior to the pressure treatment. This method utilizes the water as an “entrainer”. An “entrainer” is defined as something that draws in and/or transports solid particles and/or gas.

The present invention discloses a novel process for treating porous materials with antimicrobial polymers. Examples of porous materials that may be treated according to the process of present of present invention are natural stone, artificial stone, mineral, concrete, wood, plaster, glass, clay, cement, mortar, ceramic, and combinations thereof.

Once the porous materials are treated according to the present invention, they may be used in the protection of the surfaces of constructions, buildings, and monuments. The building materials of such surface-protected constructions, buildings, and monuments may be natural stone, artificial stone, mineral, concrete, wood, plaster, glass, clay, cement, mortar, ceramic, and combinations thereof that have surfaces impregnated with the antimicrobial polymers according to the process of the present invention.

The present invention is explained in more detail with the aid of the following embodiment examples. As can be seen from the following examples, the process according to the present invention can significantly reduce microbial infestation of the surfaces of porous materials.

### EXAMPLES

Numerous modifications and variations on the present invention are possible in light of the above teachings. The following embodiment examples are in no way intended to narrow the scope of the teachings described above. Alternatively, the following examples demonstrate that the that present invention can significantly reduce microbial infestation of the surfaces of porous materials.

### Example 1

50 mL of dimethylaminopropylmethacrylamide (Aldrich) and 250 mL of ethanol are charged to a three-necked flask and heated to 65° C. under a stream of argon. 0.6 g of azobisisobutyronitrile dissolved in 20 mL of ethyl methyl ketone are then slowly added dropwise, with stirring. The mixture is heated to 70° C. and stirred at this temperature for 72 h. After expiry of this period, the reaction mixture is stirred into 1.5 l of deionized water, whereupon the polymeric product precipitates. The product is filtered off, and then the filter residue is washed with 100 mL of a 1:1 mixture made from ethanol/deionized water, in order to remove any residual monomers still present. The product is then dried in vacuo at 50° C. for 24 hours.

A piece of sprucewood of dimensions 40×40×300 mm is immersed for one hour at room temperature in one liter of a solution made from 5 percent by weight of the polymeric product and 95 per cent by weight of ethanol. The piece of wood thus pretreated is then placed in an autoclave, which is then charged with the same 5% strength by weight solution of the antimicrobial polymer. A pressure of 8 bar is applied at 40° C., and these conditions are maintained for one hour. After depressurization of the system, the piece of wood is removed from the autoclave and dried for 4 hours at 30° C. at a pressure of 50 mbar.

### Example 1a

One drop of a microbial suspension of Staphylococcus aureus comprising 107 microbes per mL is placed on the piece of wood from example 1. After a contact time of 4 hours, the drop is taken up by a pipette and the number of microbes in the test mixture is determined. After expiry of this time, the number of microbes has fallen to 102 microbes per mL.

### Example 1b

One drop of a microbial suspension of Pseudomonas aeruginosa comprising 107 microbes per mL is placed on the piece of wood from example 1. After a contact time of 4 hours, the drop is taken up by a pipette and the number of microbes in the test mixture is determined. After expiry of this time, the number of microbes has fallen to 104 microbes per mL.

### Example 1c

Impregnated pieces of wood from example 1 are inoculated with, respectively, Chlorella sp., Trentepohlia sp., Gloeocapsa sp., Calothrix sp. and Aspergillus niger. These specimens are then placed in an incubator for 3 weeks. In contrast to control specimens run concurrently, no growth is detectable on any of the impregnated pieces of wood.

### Example 2

50 mL of tert-butylaminoethyl methacrylate (Aldrich) and 250 mL of ethanol are charged to a three-necked flask and heated to 65° C. under a stream of argon. 0.6 g of azobisisobutyronitrile dissolved in 20 mL of ethyl methyl ketone are then slowly added dropwise, with stirring. The mixture is heated to 70° C. and stirred at this temperature for 72 h. After expiry of this period, the reaction mixture is stirred into 1.5 l of deionized water, whereupon the polymeric product precipitates. The product is filtered off, and then the filter residue is washed with 100 mL of a 1:1 mixture made from ethanol/deionized water, in order to remove any residual monomers still present. The product is then dried in vacuo at 50° C. for 24 hours.

A piece of beechwood of dimensions 40×40×300 mm is placed in an autoclave. A subatmospheric pressure of 1 mbar is then applied for a period of 5 minutes. The autoclave is then charged with one liter of a solution made from 5 per cent by weight of the polymeric product and 95 percent by weight of ethanol. A pressure of 15 bar is applied at 40° C., and these conditions are maintained for one hour. After depressurization of the system, the piece of wood is removed from the autoclave and dried for a period of 4 hours at 30° C. at a pressure of 50 mbar.

### Example 2a

One drop of a microbial suspension of Staphylococcus aureus comprising 107 microbes per mL is placed on the piece of wood from example 2. After a contact time of 4 hours, the drop is taken up by a pipette and the number of microbes in the test mixture is determined. After expiry of this time, no remaining Staphylococcus aureus microbes are detectable.

### Example 2b

One drop of a microbial suspension of Pseudomonas aeruginosa comprising 107 microbes per mL is placed on the piece of wood from example 2. After a contact time of 4 hours, the drop is taken up by a pipette and the number of microbes in the test mixture is determined. After expiry of this time, no remaining Pseudomonas aeruginosa microbes are detectable.

### Example 2c

Impregnated pieces of wood from example 2 are inoculated with, respectively, Chlorella sp., Trentepohlia sp., Gloeocapsa sp., Calothrix sp. and Aspergillus niger. These specimens are then placed in an incubator for 3 weeks. In contrast to control specimens run concurrently, no growth is detectable on any of the impregnated pieces of wood.

### Example 3

30 mL of tert-butylaminoethyl methacrylate (Aldrich), 84 g of Triton X 405 (Aldrich), 375 mL of deionized water, and 1.4 g of potassium peroxodisulfate (Aldrich) are charged to a three-necked flask and heated to 60° C. under a stream of argon. A further 340 mL of tert-butylaminoethyl methacrylate are then added dropwise over a period of 4 hours. The mixture is then stirred for a further 2 hours at 60° C., and the resultant dispersion is then allowed to cool to room temperature.

A piece of sprucewood of dimensions 40×40×300 mm is immersed for one hour at room temperature in one liter of a mixture made from 30 percent by weight of the dispersion and 70 per cent by weight of water. The piece of wood thus pretreated is then placed in an autoclave, which is then charged with the same 30% strength by weight solution of the antimicrobial dispersion. A pressure of 15 bar is applied at 40° C., and these conditions are maintained for one hour. After depressurization of the system, the piece of wood is removed from the autoclave and dried for 4 hours at 30° C. at a pressure of 50 mbar.

### Example 3a

One drop of a microbial suspension of Staphylococcus aureus comprising 107 microbes per mL is placed on the piece of wood from example 3. After a contact time of 4 hours, the drop is taken up by a pipette and the number of microbes in the test mixture is determined. After expiry of this time, the number of microbes has fallen to 102 microbes per mL.

### Example 3b

One drop of a microbial suspension of Pseudomonas aeruginosa comprising 107 microbes per mL is placed on the piece of wood from example 3. After a contact time of 4 hours, the drop is taken up by a pipette and the number of microbes in the test mixture is determined. After expiry of this time, the number of microbes has fallen to 103 microbes per mL.

### Example 3c

Impregnated pieces of wood from example 3 are inoculated with, respectively, Chlorella sp., Trentepohlia sp., Gloeocapsa sp., Calothrix sp. and Aspergillus niger. These specimens are then placed in an incubator for 3 weeks. In contrast to control specimens run concurrently, no growth is detectable on any of the impregnated pieces of wood.

### Example 4

30 mL of tert-butylaminoethyl methacrylate (Aldrich), 84 g of Triton X 405 (Aldrich), 375 mL of deionized water, and 1.4 g of potassium peroxodisulfate (Aldrich) are charged to a three-necked flask and heated to 60° C. under a stream of argon. A further 340 mL of tert-butylaminoethyl methacrylate are then added dropwise over a period of 4 hours. The mixture is then stirred for a further 2 hours at 60° C., and the resultant dispersion is then allowed to cool to room temperature.

A piece of beechwood of dimensions 40×40×300 mm is placed in an autoclave. A subatmospheric pressure of 1 mbar is then applied for a period of 5 minutes. The autoclave is then charged with one liter of a mixture made from 30 per cent by weight of the polymeric dispersion and 70 percent by weight of water. A pressure of 15 bar is applied at 40° C., and these conditions are maintained for one hour. After depressurization of the system, the piece of wood is removed from the autoclave and dried for a period of 4 hours at 30° C. at a pressure of 50 mbar.

### Example 4a

One drop of a microbial suspension of Staphylococcus aureus comprising 107 microbes per mL is placed on the piece of wood from example 4. After a contact time of 4 hours, the drop is taken up by a pipette and the number of microbes in the test mixture is determined. After expiry of this time, no remaining Staphylococcus aureus microbes are detectable.

### Example 4b

One drop of a microbial suspension of Pseudomonas aeruginosa comprising 107 microbes per mL is placed on the piece of wood from example 4. After a contact time of 4 hours, the drop is taken up by a pipette and the number of microbes in the test mixture is determined. After expiry of this time, no remaining Pseudomonas aeruoginosa microbes are detectable.

### Example 4c

Impregnated pieces of wood from example 4 are inoculated with, respectively, Chlorella sp., Trentepohlia sp., Gloeocapsa sp., Calothrix sp. and Aspergillus niger. These specimens are then placed in an incubator for 3 weeks. In contrast to control specimens run concurrently, no growth is detectable on any of the impregnated pieces of wood.

### Example 5

200 mL of tert-butylaminoethyl methacrylate (Aldrich) and 1 g of azobisisobutyronitrile are placed between two glass plates. The plates have been fixed parallel with a separation of 1.5 cm, covered with cellophane film, and sealed at the edges. This rig is placed in a waterbath at 70° C. for a period of 6 hours. After expiry of this time, the rig is removed and, after cooling to room temperature, the plates are separated from one another. The polymeric product is removed and ground in a mortar.

A piece of sprucewood of dimensions 40×40×300 mm is immersed for one hour at room temperature in one liter of a solution made from 5 percent by weight of the polymeric product and 95 per cent by weight of ethanol. The piece of wood thus pretreated is then placed in an autoclave, which is then charged with the same 5% strength by weight solution of the antimicrobial polymer. A pressure of 15 bar is applied at 40° C., and these conditions are maintained for one hour. After depressurization of the system, the piece of wood is removed from the autoclave and dried for 4 hours at 30° C. at a pressure of 50 mbar.

### Example 5a

One drop of a microbial suspension of Staphylococcus aureus comprising 107 microbes per mL is placed on the piece of wood from example 5. After a contact time of 4 hours, the drop is taken up by a pipette and the number of microbes in the test mixture is determined. After expiry of this time, the number of microbes has fallen to 102 microbes per mL.

### Example 5b

One drop of a microbial suspension of Pseudomonas aeruginosa comprising 107 microbes per mL is placed on the piece of wood from example 5. After a contact time of 4 hours, the drop is taken up by a pipette and the number of microbes in the test mixture is determined. After expiry of this time, the number of microbes has fallen to 104 microbes per mL.

### Example 5c

Impregnated pieces of wood from example 5 are inoculated with, respectively, Chlorella sp., Trentepohlia sp., Gloeocapsa sp., Calothrix sp. and Aspergillus niger. These specimens are then placed in an incubator for 3 weeks. In contrast to control specimens run concurrently, no growth is detectable on any of the impregnated pieces of wood.

### Example 6

60 g of 3-aminopropyl vinyl ether (Aldrich), 60 g of methyl methacrylate (Aldrich) and 600 mL of ethanol are charged to a three-necked flask and heated to 65° C. under a stream of argon. 1.5 g of azobisisobutyronitrile dissolved in 20 mL of ethyl methyl ketone are then slowly added dropwise, with stirring. The mixture is heated to 70° C. and stirred at this temperature for 72 h. After expiry of this period, the reaction mixture is stirred into 3 l of deionized water, whereupon the polymeric product precipitates. The product is filtered off, and then the filter residue is washed with 1000 mL of deionized water, in order to remove any residual monomers still present. The product is then dried in vacuo at 50° C. for 24 hours.

A piece of beechwood of dimensions 40×40×300 mm is immersed for one hour at room temperature in one liter of a solution made from 5 percent by weight of the polymeric product and 95 per cent by weight of ethanol. The piece of wood thus pretreated is then placed in an autoclave, which is then charged with the same 5% strength by weight solution of the antimicrobial polymer. A pressure of 15 bar is applied at 40° C., and these conditions are maintained for one hour. After depressurization of the system, the piece of wood is removed from the autoclave and dried for 4 hours at 30° C. at a pressure of 50 mbar.

### Example 6a

One drop of a microbial suspension of Staphylococcus aureus comprising 107 microbes per mL is placed on the piece of wood from example 6. After a contact time of 4 hours, the drop is taken up by a pipette and the number of microbes in the test mixture is determined. After expiry of this time, the number of microbes has fallen to 102 microbes per mL.

### Example 6b

One drop of a microbial suspension of Pseudomonas aeruginosa comprising 107 microbes per mL is placed on the piece of wood from example 6. After a contact time of 4 hours, the drop is taken up by a pipette and the number of microbes in the test mixture is determined. After expiry of this time, the number of microbes has fallen to 102 microbes per mL.

### Example 6c

Impregnated pieces of wood from example 6 are inoculated with, respectively, Chlorella sp., Trentepohlia sp., Gloeocapsa sp., Calothrix sp. and Aspergillus niger. These specimens are then placed in an incubator for 3 weeks. In contrast to control specimens run concurrently, no growth is detectable on any of the impregnated pieces of wood.

### Example 7

30 mL of tert-butylaminoethyl methacrylate (Aldrich), 84 g of Triton X 405 (Aldrich), 375 mL of deionized water, and 1.4 g of potassium peroxodisulfate (Aldrich) are charged to a three-necked flask and heated to 60° C. under a stream of argon. A further 340 mL of tert-butylaminoethyl methacrylate are then added dropwise over a period of 4 hours. The mixture is then stirred for a further 2 hours at 60° C., and the resultant dispersion is then allowed to cool to room temperature.

A piece of beechwood of dimensions 40×40×300 mm is placed in an autoclave and treated with steam at 120° C. for a period of 10 minutes. The autoclave is then charged with one liter of a mixture made from 30 percent by weight of the polymeric dispersion and 70 percent by weight of water. A pressure of 10 bar is applied at 40° C., and these conditions are maintained for 10 minutes. After depressurization of the system, the piece of wood is removed from the autoclave and dried for a period of 4 hours at 30° C. at a pressure of 50 mbar.

### Example 7a

One drop of a microbial suspension of Staphylococcus aureus comprising 107 microbes per mL is placed on the piece of wood from example 7. After a contact time of 4 hours, the drop is taken up by a pipette and the number of microbes in the test mixture is determined. After expiry of this period, no remaining Staphylococcus aureus microbes are detectable.

### Example 7b

One drop of a microbial suspension of Pseudomonas aeruginosa comprising 107 microbes per mL is placed on the piece of wood from example 7. After a contact time of 4 hours, the drop is taken up by a pipette and the number of microbes in the test mixture is determined. After expiry of this period, no remaining Pseudomonas aeruginosa microbes are detectable.

### Example 7c

Impregnated pieces of wood from example 7 are inoculated with, respectively, Chlorella sp., Trentepohlia sp., Gloeocapsa sp., Calothrix sp. and Aspergillus niger. These specimens are then placed in an incubator for 3 weeks. In contrast to control specimens run concurrently, no growth is detectable on any of the impregnated pieces of wood.

### Example 8

200 mL of tert-butylaminoethyl methacrylate (Aldrich) and 1 g of azobisisobutyronitrile are placed between two glass plates. The plates have been fixed parallel with a separation of 1.5 cm, covered with cellophane film, and sealed at the edges. This rig is placed in a waterbath at 70° C. for a period of 6 hours. After expiry of this time, the rig is removed and, after cooling to room temperature, the plates are separated from one another. The polymeric product is removed and ground in a mortar.

A piece of sandstone of dimensions 10×10×80 mm is placed in an autoclave. A subatmospheric pressure of 1 mbar is then applied for a period of 5 minutes. The autoclave is then charged with one liter of a mixture made from 30 percent by weight of the polymeric dispersion and 70 percent by weight of water. A pressure of 15 bar is applied at 40° C., and these conditions are maintained for one hour. After depressurization of the system, the piece of sandstone is removed from the autoclave and dried for a period of 4 hours at 30° C. at a pressure of 50 mbar.

### Example 8a

One drop of a microbial suspension of Staphylococcus aureus comprising 107 microbes per mL is placed on the piece of sandstone from example 8. After a contact time of 4 hours, the drop is taken up by a pipette and the number of microbes in the test mixture is determined. After expiry of this time, no remaining Staphylococcus aureus microbes are detectable.

### Example 8b

One drop of a microbial suspension of Pseudomonas aeruginosa comprising 107 microbes per mL is placed on the piece of sandstone from example 8. After a contact time of 4 hours, the drop is taken up by a pipette and the number of microbes in the test mixture is determined. After expiry of this time, no remaining Pseudomonas aeruginosa microbes are detectable.

### Example 8c

Impregnated pieces of sandstone from example 8 are inoculated with, respectively, Chlorella sp., Trentepohlia sp., Gloeocapsa sp., Calothrix sp. and Aspergillus niger. These specimens are then placed in an incubator for 3 weeks. In contrast to control specimens run concurrently, no growth is detectable on any of the impregnated pieces of sandstone.

The present application claims priority to German Application No. DE 10138407.6, filed on Aug. 4, 2001, which is hereby incorporated by reference in its entirety.

Numerous modifications and variations on the present invention are possible in light of the above teachings. It is, therefore, to be understood that within the scope of the accompanying claims, the invention may be practiced otherwise than as specifically described herein.

What is claimed is:

1. A process for impregnating a porous material with an antimicrobial polymer, comprising:
applying a solution or a dispersion medium comprising an antimicrobial polymer to the porous material; and then
exposing the porous material to a pressure of from 2 to 100 bar.

2. The process according to claim 1, wherein the solution or dispersion medium comprising the antimicrobial polymer is dried on the porous material before exposing the porous material to the pressure of from 2 to 100 bar.

3. The process according to claim 1, wherein the solution or dispersion medium is removed from the porous material, leaving the antimicrobial polymer in contact with the porous material, before the porous material is exposed to the pressure of from 2 to 100 bar.

4. The process according to claim 1, wherein the porous material comprises at least one member selected from the group consisting of natural stone, artificial stone, mineral, concrete, wood, plaster, glass, clay, cement, mortar, and ceramic.

5. The process according to claim 1, wherein the antimicrobial polymers are prepared from at least one member selected from the group consisting of a nitrogen-functionalized monomer and a phosphorus-functionalized monomer.

6. The process according to claim 1, wherein the antimicrobial polymer is a copolymer comprising at least one monomer selected from the group consisting of methacrylate, acrylic acid, tert-butyl methacrylate, methyl methacrylate, styrene, vinyl chloride, vinyl ether, acrylamide, acrylonitrile, olefin, allyl compound, vinyl ketone, vinyl acetic acid, vinyl acetate, vinyl ester, ethyl methacrylate, butyl methacrylate, methyl acrylate, ethyl acrylate, butyl acrylate and tert-butyl acrylate.

7. The process according to claim 1, wherein the antimicrobial polymer is prepared from at least one monomer selected from the group consisting of 2-tert-butylaminoethyl methacrylate, 2-diethylamino-ethyl methacrylate, 2-diethylaminomethyl methacrylate, 2-tert-butylaminoethyl acrylate, 3-dimethylaminopropyl acrylate, 2-diethyl-aminoethyl acrylate, 2-dimethylaminoethyl acrylate, dimethylaminopropylmethacrylamide, diethylamino-propylmethacrylamide, N-3-dimethylaminopropyl-acrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, allyltriphenylphosphonium bromide, allyltriphenyl-phosphonium chloride, 2-acrylamido-2-methyl-1-propanesulfonic acid, 2-diethylaminoethyl vinyl ether and 3-aminopropyl vinyl ether.

8. The process according to claim 1, wherein the porous material is exposed to a pressure of from 2 to 50 bar.

9. The process according to claim 1, wherein the porous material is exposed to a pressure of from 5 to 25 bar.

10. The process according to claim 1, wherein the solution comprising the antimicrobial polymer further comprises at least one solvent selected from the group consisting of ethanol, methanol, propanol, isopropanol, ethyl acetate, butyl acetate, acetone, methyl ethyl ketone, toluene, xylene, THF, diethyl ether, dioxane, DMF, n-hexane and cyclohexane.

11. The process according to claim 1, wherein the dispersion medium further comprises at least one emulsifier, surfactant, alcohol, or combination thereof.

12. The process according to claim 1, wherein the solution or the dispersion medium comprising the antimicrobial polymer is applied to the porous material by brush, spray, or immersion.

13. The process according to claim 1, further comprising exposing the porous material to subatmospheric pressure prior to applying the solution or the dispersion medium to the porous material.

14. The process according to claim 1, further comprising exposing the porous material to subatmospheric pressure prior to exposing the porous material to the pressure of from 2 to 100 bar.

15. The process according to claim 1, further comprising exposing the porous material to subatmospheric pressure after exposing the porous material to the pressure of from 2 to 100 bar.

16. The process according to claim 1, further comprising treating the porous material with steam.

17. A porous material made by the process according to claim 1.

18. A building, comprising the porous material according to claim 17.

19. A monument, comprising the porous material according to claim 17.

20. A construction, comprising the porous material according to claim 17.

21. A process for preparing a construction, building, or monument, comprising applying a solution or dispersion comprising an antimicrobial polymer to a porous material; and then
exposing the porous material to a pressure of from 2 to 100 bar; and then
constructing the construction, building, or monument with a building material comprising the porous material.

22. A process of impregnating porous materials with an antimicrobial polymer, comprising exposing a porous material to which an antimicrobial polymer has been applied at a pressure of from 2 to 100 bar.

23. The process according to claim 22, wherein the porous material comprises at least one member selected from the group consisting of natural stone, artificial stone, mineral, concrete, wood, plaster, glass, clay, cement, mortar, and ceramic.

24. The process according to claim 22, wherein the antimicrobial polymers are prepared from at least one member selected from the group consisting of a nitrogen-functionalized monomer and a phosphorus-functionalized monomer.

25. The process according to claim 22, wherein the antimicrobial polymer is a copolymer comprising at least one monomer selected from the group consisting of methacrylate, acrylic acid, tert-butyl methacrylate, methyl methacrylate, styrene, vinyl chloride, vinyl ether, acrylamide, acrylonitrile, olefin, allyl compound, vinyl ketone, vinyl acetic acid, vinyl acetate, vinyl ester, ethyl methacrylate, butyl methacrylate, methyl acrylate, ethyl acrylate, butyl acrylate and tert-butyl acrylate.

26. The process according to claim 22, wherein the antimicrobial polymer is prepared from at least one monomer selected from the group consisting of 2-tert-butylaminoethyl methacrylate, 2-diethylamino-ethyl methacrylate, 2-diethylaminomethyl methacrylate, 2-tert-butylaminoethyl acrylate, 3-dimethylaminopropyl acrylate, 2-diethyl-aminoethyl acrylate, 2-dimethylaminoethyl acrylate, dimethylaminopropylmethacrylamide, diethylamino-propylmethacrylamide, N-3-dimethylaminopropyl-acrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, allyltriphenylphosphonium bromide, allyltriphenyl-phosphonium chloride, 2-acrylamido-2-methyl-1-propanesulfonic acid, 2-diethylaminoethyl vinyl ether and 3-aminopropyl vinyl ether.

27. The process according to claim 22, wherein the porous material to which an antimicrobial polymer has been applied is exposed to a pressure of from 2 to 100 bar in the presence of a solvent comprising at least one member selected from the group consisting of ethanol, methanol, propanol, isopropanol, ethyl acetate, butyl acetate, acetone, methyl ethyl ketone, toluene, xylene, THF, diethyl ether, dioxane, DMF, n-hexane and cyclohexane.

28. A porous material made by the process according to claim 22.

29. A building, comprising the porous material according to claim 28.

30. A monument, comprising the porous material according to claim 28.

31. A construction, comprising the porous material according to claim 28.

32. A process for preparing a construction, building, or monument, comprising
exposing a porous material to which an antimicrobial polymer has been applied at a pressure of from 2 to 100 bar; and then
using the porous material as a building material of a construction, building, or monument.
